(19) United States
(12) Patent Application Publication
(10) Pub. No.: US 2011/0314362 A1
(43) Pub. Date: Dec. 22, 2011

(54) System and Method for Displaying Relevant Data in Relation to Tiled Document Images

(76) Inventor: Ric B. Richardson, Beaverton, OR (US)

(21) Appl. No.: 12/817,104

(22) Filed: Jun. 16, 2010

(51) Int. Cl. G06F 17/00

(52) U.S. Cl. 715/205; 715/234

(57) ABSTRACT

Devices and methods are provided for displaying digital publications and related information. In one embodiment, the method may involve: receiving a user selection for at least one of a digital publication and a new location within the publication; loading tiles into a viewing area of a display page, each tile comprising graphic page information for the publication; and calculating a center location of the viewing area. The method may involve: identifying a center tile in which the center location is located; calculating a time lag corresponding to how long the center tile has been viewed by a user; and in response to the time lag being equal to or greater than a defined time period, displaying selected data on the display page, the data being selected based at least in part on the graphic page information displayed in the center tile.

### BACKGROUND

Display of web page address related data is common practice on the web today. Most notably Google has a system that enables advertising related to a specific page address or text content within a web page allowing it to display relevant advertising for that specific page in an area of the same page set aside for displaying advertising text.

Google Maps displays relevant information and advertising related to location specific information. In this case, the geo location being displayed to the user in the Google Maps viewing page is related to a database of businesses or advertising entries which are then displayed in an area set aside for this purposes on the edge of the screen.

However, there are limits to using such known technologies for viewing digital publications (e.g., digital newspapers or publications), and there remains a need for an approach to relating digital publication tiles to specific relevant data, and more specifically advertising related to the digital publication being displayed to the user in a browser.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with methods for displaying digital publications and related information. The method may involve receiving a user selection for at least one of a digital publication and a new location within the publication. The method may involve loading tiles into a viewing area of a display page, each tile comprising graphic page information for the publication. The method may involve calculating a center location of the viewing area. The method may involve identifying a center tile in which the center location is located. The method may involve calculating a time lag corresponding to how long the center tile has been viewed by a user. The method may involve, in response to the time lag being equal to or greater than a defined time period, displaying selected data on the display page, the data being selected based at least in part on the graphic page information displayed in the center tile.

In accordance with one or more embodiments and corresponding disclosure thereof, various aspects are described in connection with devices and apparatuses for displaying digital publications and related information. For example, the apparatus may include a module for receiving a user selection for at least one of a digital publication and a new location within the publication. The apparatus may include a module for loading tiles into a viewing area of a display page, each tile comprising graphic page information for the publication. The apparatus may include a module for calculating a center location of the viewing area. The apparatus may include a module for identifying a center tile in which the center location is located. The apparatus may include a module for calculating a time lag corresponding to how long the center tile has been viewed by a user. The apparatus may include a module for, in response to the time lag being equal to or greater than a defined time period, displaying selected data on the display page, the data being selected based at least in part on the graphic page information displayed in the center tile.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWING

FIG. 1 is an example pictorial embodiment of a tile based advertising system.

FIG. 2 is an example of an advertisement selection system.

FIG. 3 is an example of a tile monitoring system.

FIG. 4 illustrates an example methodology for displaying a digital publication.

FIGS. 5-6 illustrate further aspects of the methodology of FIG. 4.

FIG. 7 shows an exemplary apparatus for displaying a digital publication.

### DETAILED DESCRIPTION

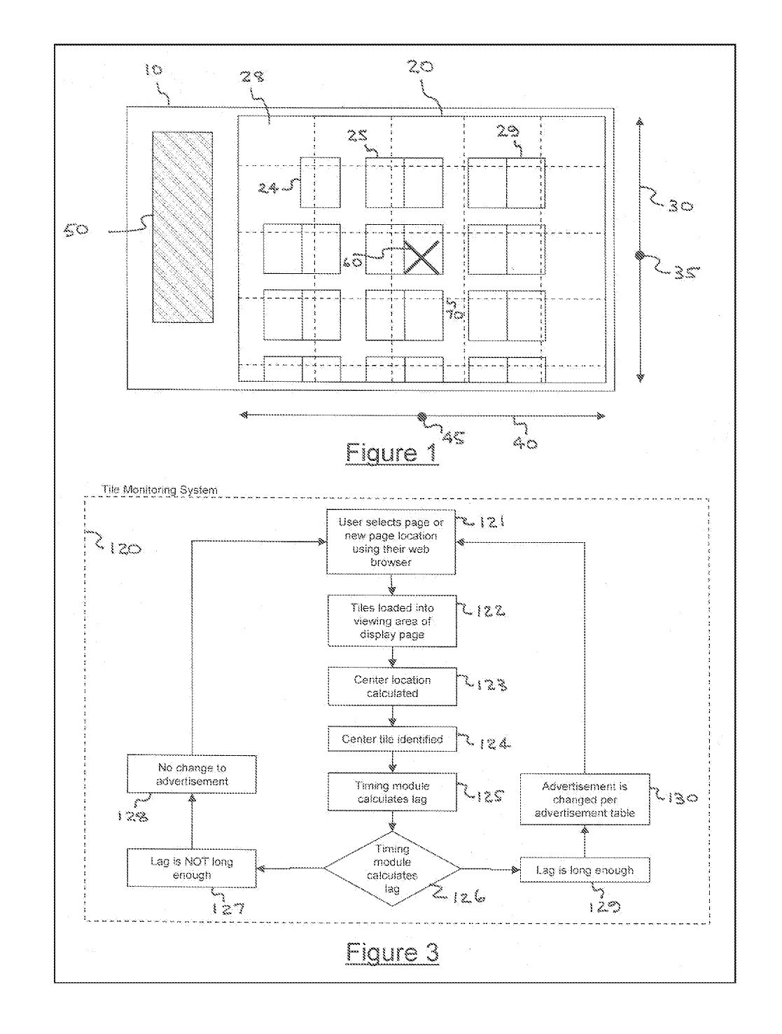

FIG. 1 describes an example of a tile based publication display 10. The main viewing area of the page 20 is composed of a series of graphic tiles 28 that are usually two hundred and fifty six pixels in width and height and are loaded into the viewing area 20 as the user navigates around the publication. Each graphic tile 28 contains graphic page information 29 for the digital publication being displayed to the user. Graphic page information can be in the form of single pages 24 and double page spreads 25.

A separate part of the page displays data 50 related to the specific part of the digital publication being displayed. In this embodiment, the related data is a vertical graphic advertisement 50 often called a skyscraper ad in the art.

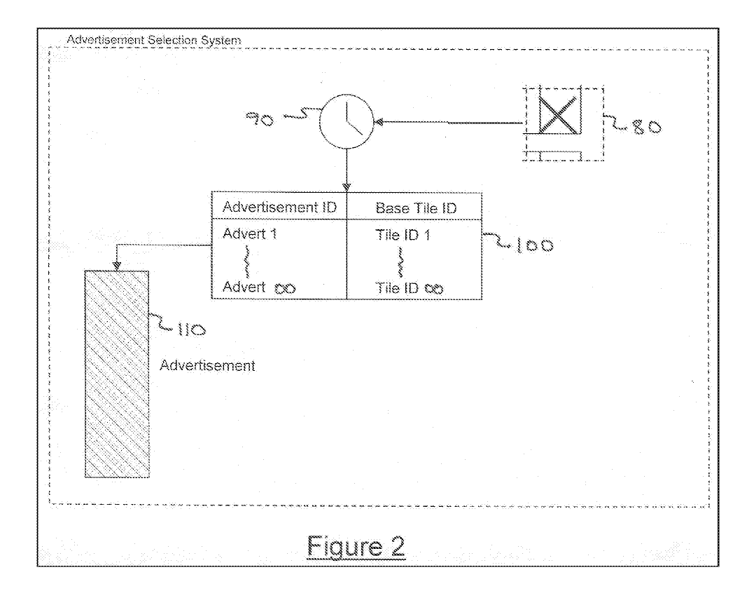

This advertisement is changed related to a advertisement selection system 120 an example embodiment of which is shown in FIG. 2. The advertisement selection system 120 in this embodiment monitors which tile is at the center 60 by width 40 and height 30 of the users viewing area. In this case the center location 60 of the viewing area is calculated by halving 45 the width 40 and halving 35 the height 30 of the viewing area 20. This information 60 is then used to select the center tile 70 and a relevant advertisement 50 is displayed in the related data display area.

As shown in FIG. 2 the selection of the related advertisement 110 is made by way of a timing calculation 90 based on how long the center tile 80 has been displayed to the user and subsequently a table of related data or advertisements is invoked 100. In FIG. 2 the center tile 80 is the equivalent counterpart of the center tile 70 in FIG. 1. The timing module 90 is used to delay the change of the advertisement in the event that the user is simply momentarily viewing the selected tile 80 while navigating to other areas of the digital publication. This feature is designed to minimize the irritation that could be experienced by the user if the related data or advertisement 110 was not displayed for a long enough period to be comfortably read and to avoid visual confusion.

The result is that advertisements can be tagged, linked and displayed related to tiles that represent a whole digital publication, individual page or pages of a publication, or even very small individual areas on a page in the digital publication.

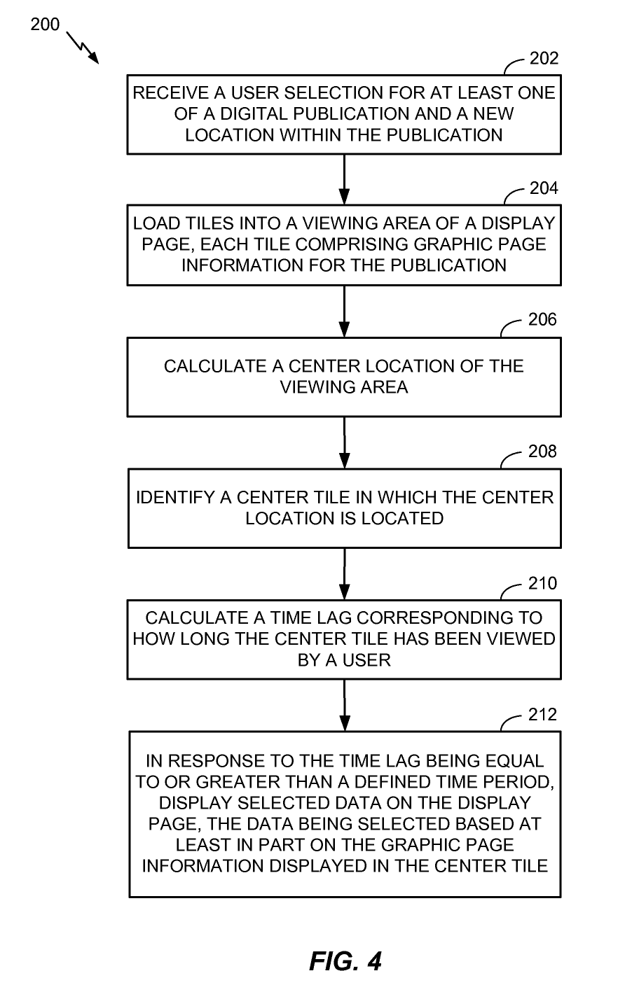

FIG. 3 shows a tile monitoring system 120. In the example embodiment, the tile based document is loaded by the user usually by selecting a page from the internet into their web browser or by the user navigating to a new location in the publication being viewed 121. Upon load of the digital publication, tiles are loaded into the main viewing area of the web page 122. In this embodiment, the tile at the center of the viewing area is calculated by width and height 123. The tile is identified 124 and then this information is sent to the timing module. The timing module is set to ensure that the selected tile has been viewed by the user for a period long enough to warrant the display of related and relevant information and to display this information for a period or lag 125 that will ensure the user can comfortably read the information before it is changed in the event the user moves on to another area of the digital publication.

If these criteria are not met 127 then the identity of the selected tile is not passed on to the table 128 of related data or advertisements and the system starts another cycle of tile monitoring.

If these criteria are met 129 then the identity of the selected tile is passed on to the table of related data or advertisements and a related advertisement or data set is displayed 130 to the user in the related data viewing area.

The result of the above system is that relevant data or advertising is displayed to the user in a visually pleasing way as they navigate and move through tile based digital publications.

The example embodiment uses a skyscraper advertisement on the left hand side of the page. However, other embodiments could display related non advertising data from the web or other sources as the user navigates the digital publication. Examples of other data that could be displayed include and are not limited to text from an article being displayed in the main viewing area, publication information, footnotes or hyperlinks to expanded information on subject matter from the page or pages being viewed in the main viewing area.

In other embodiments, the related data could be displayed at other places on the page or as an overlay that is displayed on top of the digital publication being viewed. The data could be displayed in other windows on the same computer or in display areas running on separate computers. This could be used in situations where a central screen is being used for document navigation and related data is being displayed on separate monitors. An example of this would be in a point of sale or kiosk system in a store where related information is displayed separately and allows independent navigation.

In another embodiment of the system, the table used to chose which related data set or advertisement to display could make the decision not only on the tile at the center of the viewing area but on the tiles being displayed, or on a calculation based on the tiles that were recently viewed by the user. For example, if the user is viewing a publication page that has multiple advertisements associated with it, then the tile tagging system could be set to choose to display the related data that is linked to the most tiles being viewed in the viewing area.

In another embodiment, the tagging system can be used to calculate the relevant data to display in relation to the level of magnification or zoom being used by the user. A feature of the tiling technology, also well known in the art, is the ability to view tiled mapping information at different levels of magnification or zoom. The digital publication can similarly viewed at different levels of zoom. On this basis the tagging system can be used to calculate the most relevant data set or advertisement to display based on the tiled publication pages being displayed and their level of zoom. For example, a link to display an advertisement linked to an area of a page that can not be easily read by the user may not be displayed until the user zooms into the publication page to a magnification level that allows the user to easily read the target information and can easily understand and recognize the significance and value of the advertisement or data set displayed in the related data set display area.

In another embodiment, not only individual tiles are linked to related data sets, but individual regions or areas of each tile can be linked. This would be desirable where very specific related data is to be displayed to very specific area of target publication page and tile area. An example of this could be where related data or advertising needs to be displayed related to a specific word, paragraph or graphic displayed graphically on part of a tile that is displaying a part of a page of a digital publication.

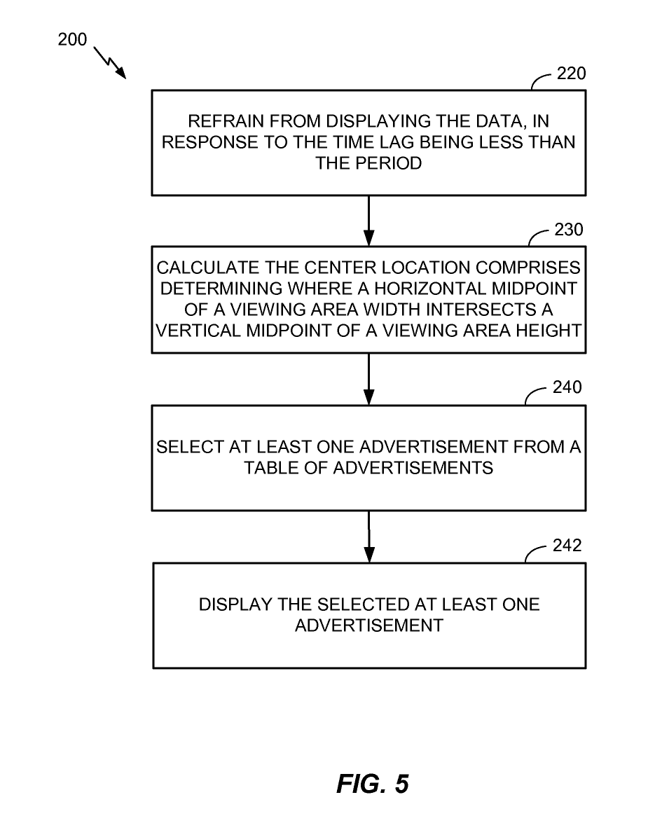

In accordance with one or more aspects of the embodiments described herein, with reference to FIG. 4, a methodology relating to selective display of information relating to a digital publication is illustrated. While, for purposes of simplicity of explanation, the methodology is shown and described as a series of acts, it is to be understood and appreciated that the methodology is not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

With continued reference to FIG. 4, illustrated is a methodology 200 that may be performed on a computing, networking, or communications device, or the like. At 202, the method 200 may involve receiving a user selection for at least one of a digital publication and a new location within the publication. At 204, the method 200 may involve loading tiles into a viewing area of a display page, each tile comprising graphic page information for the publication. At 206, the method 200 may involve calculating a center location of the viewing area. At 208, the method 200 may involve identifying a center tile in which the center location is located. At 210, the method 200 may involve calculating a time lag corresponding to how long the center tile has been viewed by a user. At 212, the method 200 may involve, in response to the time lag being equal to or greater than a defined time period, displaying selected data on the display page, the data being selected based at least in part on the graphic page information displayed in the center tile.

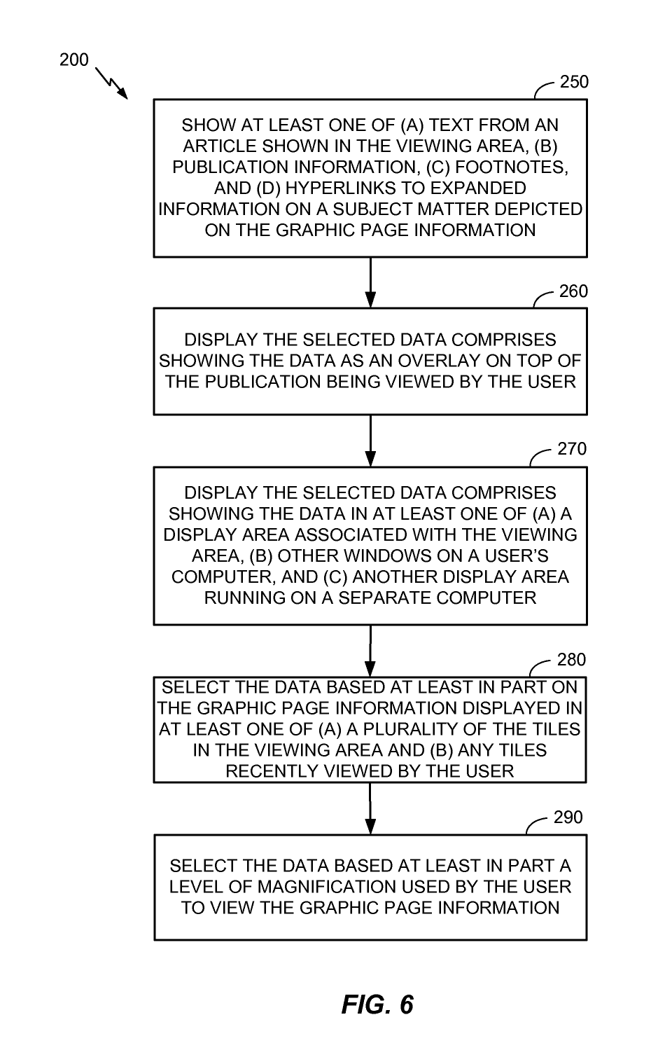

With reference to FIG. 5, in related aspects, the method 200 may involve, at 220, refraining from displaying the data, in response to the time lag being less than the period. The graphic page information may be in the form of at least one of a single page and a double page spread. At 230, the method 200 may involve calculating the center location comprises determining where a horizontal midpoint of a viewing area width intersects a vertical midpoint of a viewing area height.

In further related aspects, the graphic page information may comprise advertising relevant to the publication. At 240, the method 200 may involve selecting at least one advertisement from a table of advertisements and, at 242, displaying the selected at least one advertisement. The at least one advertisement may be associated with one or more tiles that represent at least one of (a) the publication, (b) an individual page or pages of the publication, and (c) a defined area on a given page of the publication.

With reference to FIG. 6, in yet further related aspects, the method 200 may involve, at 250, showing at least one of (a) text from an article shown in the viewing area, (b) publication information, (c) footnotes, and (d) hyperlinks to expanded information on a subject matter depicted on the graphic page information. At 260, the method 200 may involve displaying the selected data comprises showing the data as an overlay on top of the publication being viewed by the user. At 270, the method 200 may involve displaying the selected data comprises showing the data in at least one of (a) a display area associated with the viewing area, (b) other windows on a user's computer, and (c) another display area running on a separate computer. At 280, the method 200 may involve selecting the data based at least in part on the graphic page information displayed in at least one of (a) a plurality of the tiles in the viewing area and (b) any tiles recently viewed by the user. At 290, the method 200 may involve selecting the data based at least in part a level of magnification used by the user to view the graphic page information.

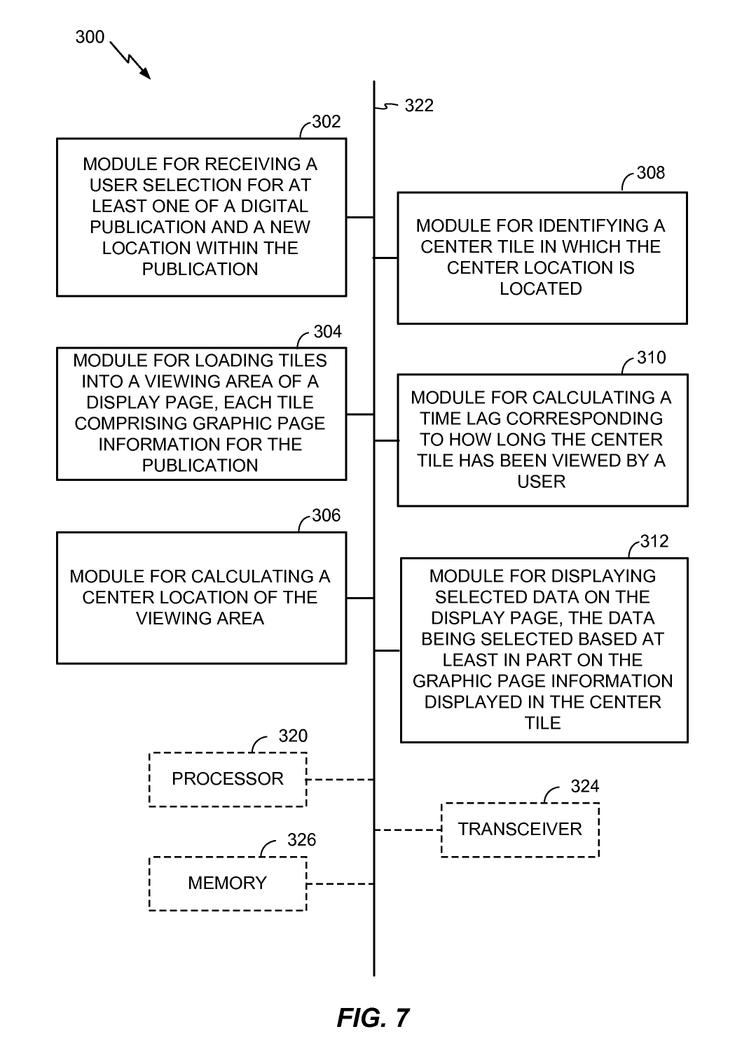

In accordance with one or more aspects of the embodiments described herein, there are provided devices and apparatuses for displaying digital publications and related information. With reference to FIG. 7, there is provided an exemplary apparatus 300 that may be configured as a computing device or as a processor or similar device for use within the computing device. As depicted, the apparatus 300 may include functional blocks that can represent functions implemented by a processor, software, or combination thereof (e.g., firmware).

As illustrated, in one embodiment, the apparatus 300 may comprise an electrical component or a module 302 for receiving a user selection for at least one of a digital publication and a new location within the publication. The apparatus 300 may comprise a module 304 for loading tiles into a viewing area of a display page, each tile comprising graphic page information for the publication. The apparatus 300 may comprise a module 306 for calculating a center location of the viewing area. The apparatus 300 may comprise a module 308 for identifying a center tile in which the center location is located. The apparatus 300 may comprise a module 310 for calculating a time lag corresponding to how long the center tile has been viewed by a user. The apparatus 300 may comprise a module 312 for, in response to the time lag being equal to or greater than a defined time period, displaying selected data on the display page, the data being selected based at least in part on the graphic page information displayed in the center tile.

In related aspects, the apparatus 300 may optionally include a processor module 320 having at least one processor, in the case of the apparatus 300 configured as a communication network entity, rather than as a processor. The processor 320, in such case, may be in operative communication with the modules 302-312 via a bus 322 or similar communication coupling. The processor 320 may effect initiation and scheduling of the processes or functions performed by electrical components 302-312.

In related aspects, the apparatus 300 may include a radio transceiver module 324. A stand alone receiver and/or stand alone transmitter may be used in lieu of or in conjunction with the transceiver 324. In further related aspects, the apparatus 300 may optionally include a module for storing information, such as, for example, a memory device/module 326. The computer readable medium or the memory module 326 may be operatively coupled to the other components of the apparatus 300 via the bus 322 or the like. The memory module 326 may be adapted to store computer readable instructions and data for effecting the processes and behaviour of the modules 302-312, and subcomponents thereof, or the processor 320, or the methods disclosed herein. The memory module 326 may retain instructions for executing functions associated with the modules 302-312. While shown as being external to the memory 326, it is to be understood that the modules 302-312 can exist within the memory 326.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes Compact Disc (CD), laser disc, optical disc, Digital Versatile Disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method, comprising:
receiving a user selection for at least one of a digital publication and a new location within the publication;
loading tiles into a viewing area of a display page, each tile comprising graphic page information for the publication;
calculating a center location of the viewing area;
identifying a center tile in which the center location is located;
calculating a time lag corresponding to how long the center tile has been viewed by a user; and
in response to the time lag being equal to or greater than a defined time period, displaying selected data on the display page, the data being selected based at least in part on the graphic page information displayed in the center tile.

2. The method of claim 1, further comprising refraining from displaying the data, in response to the time lag being less than the period.

3. The method of claim 1, wherein the graphic page information may be in the form of at least one of a single page and a double page spread.

4. The method of claim 1, wherein calculating the center location comprises determining where a horizontal midpoint of a viewing area width intersects a vertical midpoint of a viewing area height.

5. The method of claim 1, wherein the graphic page information comprises advertising relevant to the publication.

6. The method of claim 5, wherein displaying the data comprises:
selecting at least one advertisement from a table of advertisements; and
displaying the selected at least one advertisement.

7. The method of claim 5, wherein the at least one advertisement is associated with one or more tiles that represent at least one of (a) the publication, (b) an individual page or pages of the publication, and (c) a defined area on a given page of the publication.

8. The method of claim 1, wherein displaying the selected data comprises showing at least one of (a) text from an article shown in the viewing area, (b) publication information, (c) footnotes, and (d) hyperlinks to expanded information on a subject matter depicted on the graphic page information.

9. The method of claim 1, wherein displaying the selected data comprises showing the data as an overlay on top of the publication being viewed by the user.

10. The method of claim 1, wherein displaying the selected data comprises showing the data in at least one of (a) a display area associated with the viewing area, (b) other windows on a user's computer, and (c) another display area running on a separate computer.

11. The method of claim 1, wherein the data is selected based at least in part on the graphic page information displayed in at least one of (a) a plurality of the tiles in the viewing area and (b) any tiles recently viewed by the user.

12. The method of claim 1, wherein the data is selected based at least in part on a level of magnification used by the user to view the graphic page information.

13. An apparatus, comprising:
a first component for receiving a user selection for at least one of a digital publication and a new location within the publication;
a second component for loading tiles into a viewing area of a display page, each tile comprising graphic page information for the publication;
a third component for calculating a center location of the viewing area;
a fourth component for identifying a center tile in which the center location is located;
a fifth component for calculating a time lag corresponding to how long the center tile has been viewed by a user; and
in response to the time lag being equal to or greater than a defined time period, a sixth component for displaying selected data on the display page, the data being selected based at least in part on the graphic page information displayed in the center tile.

14. The apparatus of claim 13, further comprising a seventh component for refraining from displaying the data, in response to the time lag being less than the period.

15. The apparatus of claim 13, wherein the graphic page information may be in the form of at least one of a single page and a double page spread.

16. The apparatus of claim 13, wherein the fifth component determines where a horizontal midpoint of a viewing area width intersects a vertical midpoint of a viewing area height.

17. The apparatus of claim 13, wherein the graphic page information comprises advertising relevant to the publication.

18. A apparatus of claim 17, wherein the sixth component selects at least one advertisement from a table of advertisements, and displays the selected at least one advertisement.

19. A apparatus of claim 17, wherein the at least one advertisement is associated with one or more tiles that represent at least one of (a) the publication, (b) an individual page or pages of the publication, and (c) a defined area on a given page of the publication.

20. The apparatus of claim 13, wherein the sixth component displays at least one of (a) text from an article shown in the viewing area, (b) publication information, (c) footnotes, and (d) hyperlinks to expanded information on a subject matter depicted on the graphic page information.

21. The apparatus of claim 13, wherein the sixth component displays the data as an overlay on top of the publication being viewed by the user.

22. The apparatus of claim 13, wherein the sixth component displays the data in at least one of (a) a display area associated with the viewing area, (b) other windows on a user's computer, and (c) another display area running on a separate computer.

23. The apparatus of claim 13, wherein the data is selected based at least in part on the graphic page information displayed in at least one of (a) a plurality of the tiles in the viewing area and (b) any tiles recently viewed by the user.

24. The apparatus of claim 13, wherein the data is selected based at least in part on a level of magnification used by the user to view the graphic page information.

25. An apparatus, comprising:
means for receiving a user selection for at least one of a digital publication and a new location within the publication;
means for loading tiles into a viewing area of a display page, each tile comprising graphic page information for the publication;
means for calculating a center location of the viewing area;
means for identifying a center tile in which the center location is located;
means for calculating a time lag corresponding to how long the center tile has been viewed by a user; and
in response to the time lag being equal to or greater than a defined time period, means for displaying selected data on the display page, the data being selected based at least in part on the graphic page information displayed in the center tile.

26. A computer program product, comprising:
a computer-readable medium comprising code for causing a computer to:
receive a user selection for at least one of a digital publication and a new location within the publication;
load tiles into a viewing area of a display page, each tile comprising graphic page information for the publication;
calculate a center location of the viewing area;
identify a center tile in which the center location is located;
calculate a time lag corresponding to how long the center tile has been viewed by a user; and
in response to the time lag being equal to or greater than a defined time period, display selected data on the display page, the data being selected based at least in part on the graphic page information displayed in the center tile.
